(19) United States
(12) Patent Application Publication
(10) Pub. No.: US 2013/0173500 A1
(43) Pub. Date: Jul. 4, 2013

(54) ELECTRONIC POWER METER AND METHOD FOR STORING DATA THEREOF

(71) Applicant: LSIS Co., Ltd., Anyang-si (KR)

(72) Inventor: Seung Ho BAEK, Cheongju (KR)

(73) Assignee: LSIS CO., LTD., Anyang-si (KR)

(21) Appl. No.: 13/719,734

(22) Filed: Dec. 19, 2012

(30) Foreign Application Priority Data
Dec. 30, 2011 (KR) 10-2011-0147284

(51) Int. Cl. G06Q 99/00; G06Q 50/06

(52) U.S. Cl. CPC G06Q 99/00; G06Q 50/06
USPC 705/412

(57) ABSTRACT

The present disclosure relates to an electronic power meter and a method for storing data thereof. The electronic power meter includes a communication unit that receives a critical peak pricing rate data, a memory that stores first metering data corresponding to the critical peak pricing rate data received via the communication unit, and second metering data corresponding to a predetermined varying pricing rate data, the memory storing the first metering data and the second metering data into different storage areas respectively, and a controller that calculates metering data by applying a corresponding rate for each time slot according to the varying pricing rate or the critical peak pricing rate.

### CROSS-REFERENCE TO RELATED APPLICATIONS

Pursuant to 35 U.S.C. §119(a), this application claims the benefit of earlier filing date and right of priority to Korean Application No. 10-2011-0147284, filed on Dec. 30, 2011, the contents of which are hereby incorporated by reference herein in their entirety.

### BACKGROUND OF THE INVENTION

1. Field of the Invention

This specification relates to an electronic power meter and a data storing method thereof, and particularly, to an electronic power meter capable of individually storing metering data for each pricing rate, and a data storing method thereof.

2. Background of the Invention

An electronic power meter detects voltage and current through a voltage and current sensors in an analog manner, converts the detected analog voltage and current into digital data using an analogy/digital converter, calculates and displays a quantity of electric power usage in a calculation and control unit (A/D converter, microcontroller), and provides the quantity of power usage (power consumption), pricing data and the like to a user and a power providing company.

The power providing company induces consumers to use a uniform amount of electric power per day to reduce facility investment costs. To this end, the power providing company takes a varying pricing rate which differentiates each rate based on a usage time slot (in other words time interval or time period), namely, may take a pricing rate, in which an expensive rate is applied to a time slot for which a large amount of electric energy is consumed, and a cheap rate is applied to a time slot for which a small amount of electric energy is consumed. Accordingly, the electronic power meter measures electric power consumption (in other words power usage, electric energy usage) for a predetermined time by dividing into time slots according to a varying pricing rate provided from the power providing company, and send the measured result to the power providing company. Then, the power providing company desires to adjust the investments into power generation facilities and transmission and distribution facilities and supply the electric power without problem by using the power consumption information (that is power consumption data) measured on the time slot basis.

In the meantime, with the development of IT technologies in recent time, the related art meter reading system which is configured for workers to measure consumers' power consumption is evolving into a remote meter reading system based on wired/wireless communication technologies.

The related art meter reading system basically functions to measure the consumer's power usage and transfer the measurement result to a management server of the power providing company. However, the power providing company provides various types of additional services and pricing rate using the power meter, focusing on importance of energy management due to environmental problems, development of IT technologies, consumers' demands on electric power data and the like.

To provide such various functions, the power meter has recently evolved into an intelligent power meter, and requirements for efficient metering data management are increasing.

### SUMMARY OF THE INVENTION

Therefore, to address such requirements, an aspect of the present disclosure is to provide a power meter capable of storing data regarding various types of pricing rate data and metering data for each pricing rate in different memory area to provide to a remote management server, and a method for storing to data thereof.

To achieve these and other advantages and in accordance with the purpose of this specification, as embodied and broadly described herein, there is provided an electronic power meter comprising:

a communication unit that receives a critical peak pricing rate data;

a memory that stores first metering data corresponding to the critical peak pricing rate data received via the communication unit, and second metering data corresponding to a predetermined varying pricing rate data, the memory storing the first metering data and the second metering data within different storage areas respectively; and

a controller that calculates the metering data by applying a corresponding rate for each time slot according to the varying pricing rate data or the critical peak pricing rate data

In accordance with one aspect of the present disclosure, the critical peak pricing rate data may include a starting time, an ending time and a peak rate with respect to a time slot for applying the critical peak pricing rate thereto.

In accordance with another aspect of the present disclosure, the controller may include a processing program that calculates the metering data by applying the peak rate when a current time belongs to the time slot for applying the critical peak pricing rate data thereto, or calculates the metering data by applying a time slot-based rate of the predetermined varying pricing rate data when the current time does not belong to the time slot for applying the critical peak pricing rate data thereto.

In accordance with another aspect of the present disclosure, the varying pricing rate data may employ a varying rate for each time slot.

To achieve these and other advantages and in accordance with the purpose of this specification, as embodied and broadly described herein, there is provided a method for storing data in an electronic power meter comprising:

storing a critical peak pricing rate data into a first memory;

calculating metering data by applying the critical peak pricing rate data or a predetermined varying pricing rate data according to a current time; and

storing first metering data corresponding to the critical peak pricing rate data and second metering data corresponding to the predetermined varying pricing rate data into different storage areas.

In accordance with another aspect of the present disclosure, the critical peak pricing rate data may include a starting time, an ending time and a peak rate with respect to a time slot for applying the critical peak pricing rate data thereto.

In accordance with another aspect of the present disclosure, the step of calculating the metering data by applying the critical peak pricing rate data or the predetermined varying pricing rate data according to the current time comprising:

calculating the metering data by applying the peak pricing rate when the current time belongs to the time slot for applying the critical peak pricing rate data thereto, or

calculating the metering data by applying a time slot-based rate of the predetermined varying pricing rate data when the current time does not belong to the time slot for applying the critical peak pricing rate data thereto.

Further scope of applicability of the present application will become more apparent from the present disclosure given hereinafter. However, it should be understood that the present disclosure and specific examples, while indicating preferred embodiments of the invention, are given by way of illustration only, since various changes and modifications within the spirit and scope of the invention will become apparent to those skilled in the art from the present disclosure.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1 is a block diagram showing a schematic configuration of an electronic power meter in accordance with a preferred exemplary embodiment of the present disclosure;

FIG. 2A is an exemplary view showing a varying pricing rate based on a time slot;

FIG. 2B is an exemplary view showing data related to a pricing rate stored in a memory.

FIG. 3 is a flowchart showing a method for storing data in an electronic power meter in accordance with a preferred exemplary embodiment of the present disclosure.

### DETAILED DESCRIPTION OF THE INVENTION

Description will now be given in detail of the exemplary embodiments, with reference to the accompanying drawings. For the sake of brief description with reference to the drawings, the same or equivalent components will be provided with the same reference numbers, and description thereof will not be repeated.

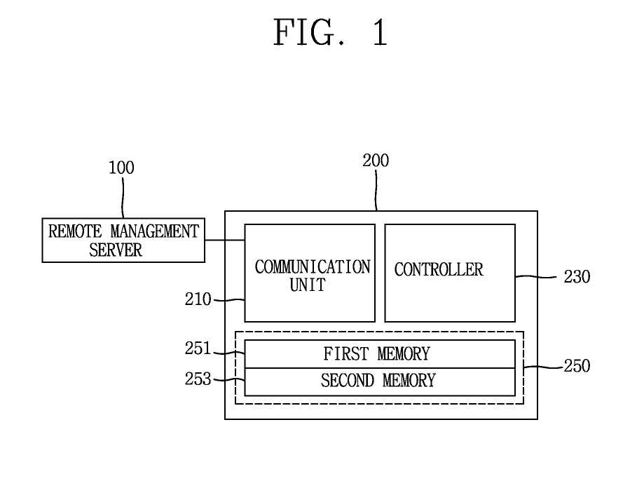

FIG. 1 is a block diagram showing a schematic configuration of an electronic power meter in accordance with a preferred exemplary embodiment of the present disclosure.

FIG. 1 shows an electronic power meter 200 according to the preferred exemplary embodiment of the present disclosure, and a remote management server 100 of a power providing company.

The remote management server 100 may receive metering data, status data and the like from the electronic power meter 200 via a data communication network, process and manage those data, and transmit a pricing rate data, an operating program and the like to the electronic power meter 200.

The electronic power meter 200 comprises a communication unit 210, a controller 230, and a memory 250. However, it is understood that implementing all of the illustrated components in FIG. 1 is not a requirement. Greater or fewer components than the ones shown in FIG. 1 may alternatively be configured for the electronic power meter 200.

The communication unit 210 may perform data transmission and reception with the remote management server 100 via a wired data communication such as optical communication, serial communication and the like, or a wireless data communication, such as Near Field Communication (NFC), Wi-Fi and the like. The communication unit 210 may receive critical peak pricing rate data (abbreviated as CPP rate data hereinafter) from the remote management server 100. The critical peak pricing rate data may include a starting time, an ending time and CPP rate data regarding an interval (that is time slot) for which the peak pricing rate is applied.

The controller 230 may execute an overall control of the electronic power meter 200, and the controller 230 is a component including a calculating unit that calculates metering data. Although not shown in FIG. 1, the electronic power meter 200 may include a voltage detector for detecting a voltage applied to an electric load, a current detector for detecting a current flows into the load, an analog/digital converter that converts analog voltage and current detected by the voltage detector and the current detector into digital voltage and current. The controller 230 may calculate metering data related to power consumption (amount of electric power usage) or the like using the digital voltage signal and the digital current signal converted by the analog/digital converter.

In the meantime, a varying pricing rate data to which a varying rate based on a time slot (time period) is applied may be predetermined (that is preset) into the electronic power meter 200. Here, the controller 230 may decide a corresponding rate based on current time data, and accordingly calculate metering data, such as power (electric energy) consumption (in other words power usage or amount of electric power used), for which the varying rate based on the time slot (time period) is applied.

The memory 250 may store a current time, time slot data and the like which correspond to the metering data calculated by the controller 230. Also, the memory 250 may store pricing rate data, such as the CPP rate data, the varying pricing rate data or the like, a processing program of the controller 230, and the like.

The memory 250 may be implemented as a variety of digital data storage media, such as an Electrically Erasable Programmable Read-Only Memory (EEPROM), a flash memory, a Random Access Memory (RAM) and the like.

The pricing rate data may include rate data based on a time slot. For the varying pricing rate data, a day may be divided into a plurality of time slots (in other words time periods), and a starting time, an ending time and rate data corresponding to each time slot may be stored as related data. For the critical peak pricing rate data, a starting time, an ending time and rate data corresponding to a time slot in which the largest amount of electric power is consumed during the day may be stored as related data.

Here, the electronic power meter 200 according to one exemplary embodiment of the present disclosure may store data related to the critical peak pricing rate data, which is received from the remote management server 100 to be applied if necessary, and metering data corresponding to the critical peak pricing rate data, and data related to the predetermined varying pricing rate data and corresponding metering data, in different storage areas. That is, the critical peak pricing rate data and the corresponding metering data may be stored into a first memory 251 of the memory 250, and the varying pricing rate data and the corresponding metering data may be stored into a second memory 253 of the memory 250.

The first memory 251 and the second memory 253 may be implemented as physically different memories from each other, or as distinguished storage areas within one memory.

As such, with the distinguished storage and management of the varying pricing rate data applied at normal times and the corresponding metering data, and the critical peak pricing rate data applied if necessary and the corresponding metering data, efficiency of data management by the electronic power meter 200 and the remote management server 100 may be enhanced.

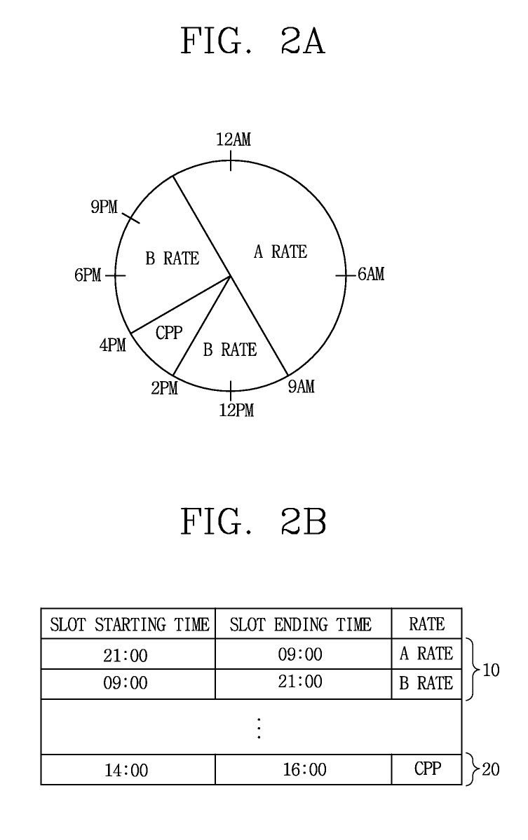

FIG. 2A is an exemplary view showing a varying pricing rate based on a time slot (time period).

As shown in FIG. 2A, a day may be divided into four time slots, and the rates may be applied to time slots.

A reference numeral 10 in FIG. 2B designates a time slot and rate data related to the varying pricing rate data predetermined in the electronic power meter 200, and a reference numeral 20 designates a time slot and rate data related to the CPP rate data provided from the remote management server 100.

Referring to FIG. 2A, the CPP rate data has an application range from 2 pm to 4 pm as a time slot in which the maximum electric power is consumed. During this time slot, a higher rate (that is CPP rate) than a rate (that is B rate) of a near time slot may be applied to lead consumers to spontaneously control their power usage, resulting in achieving stable power supply. In general, the critical peak pricing rate is not applied at all times, but temporarily applied when necessary. Hence, the remote management server 100 may provide the critical peak pricing rate data to the electronic power meter 200 when the peak pricing rate is necessary to be applied, such that the pricing rate can be temporarily used.

When the critical peak pricing rate is not required to be applied, the varying pricing rate predetermined in the electronic power meter 200 may be applied. The varying pricing rate is to apply to every other time slot except for the time slot for which the peak pricing rate is applied. That is, a rate A may be applied for a period of time from 9 PM to 9 AM of the next day as a time slot in which relatively less power is consumed, and a rate B may be applied for a period of time from 9 AM to 9 PM as a time slot in which relatively much power is consumed. On the contrary, when the critical peak pricing rate is temporarily applied, a CPP rate other than B rate may be applied to a time slot, for which the critical peak pricing rate is applied, of time slots having the rate B applied thereto.

FIG. 2B shows data related to a pricing rate stored in a memory, which shows that the varying pricing rate data 10 predetermined (in other words preset) in the electronic power meter 200 and the critical peak pricing rate data 20 provided from the remote management server 100 are stored in different storage areas within the memory.

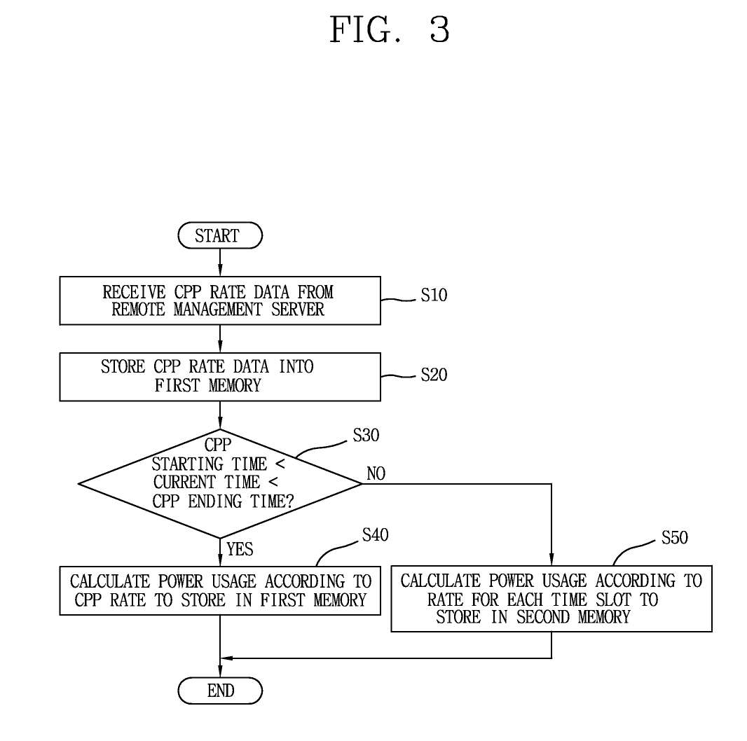

FIG. 3 is a flowchart showing a method for storing data in an electronic power meter in accordance with a preferred exemplary embodiment.

The electronic power meter 200 according to the preferred exemplary embodiment of the present disclosure may previously store data related to a varying pricing rate, which is employed at normal times, in one area of a memory, namely, a second memory 253, and apply the varying rate for each time slot according to the predetermined varying pricing rate, thereby calculating metering data.

Accordingly, in a normal state that the varying pricing rate is applied, when the critical peak pricing rate data is necessary to be applied, the electronic power meter 200 may receive data related to the CPP rate data from the remote management server 100 (S10). The CPP rate data may include a starting time, an ending time and CPP rate data related to an application range for the CPP rate data.

The electronic power meter 200 may store the CPP rate data received at S10 in one area of a memory 250, namely, the first memory 251 (S20).

To determine a rate to apply for each time slot, the electronic power meter 200 may determine a time slot to which a current time belongs by using the CPP rate data stored in the first memory 251 and the varying pricing rate data previously stored in a second memory 253. That is, the electronic power meter 200 may determine whether or not the current time is present between the starting time and the ending time of the time slot included in the CPP rate data (S30).

According to the determination result at S30, when the current time belongs to the time slot for which the CPP rate data is applied, the electronic power meter 200 may calculate metering data such as electric power consumption (in other words power usage or an amount of electric power used) according to the rate for the CPP rate data, and store the calculated metering data in one area of the memory 250, namely, the first memory 251 (S40).

According to the determination result at S30, when the current time does not belong to the time slot for which the CPP rate data is applied, the electronic power meter 200 may calculate metering data such as the electric power consumption (in other words power usage or an amount of electric power used) by applying the varying rate for each time slot according to the varying pricing rate, and store the calculated metering data in one area of the memory 250, namely, the second memory 253 (S50).

As such, the electronic power meter 200 according to the preferred exemplary embodiment may increase efficiency of data management by storing various data related to the normally applied varying pricing rate data and the temporarily applied CPP rate data in separate storage areas within a memory 250.

As described above, an electronic power meter may obtain an advantage of efficiently managing metering data by way of storing, within different memory areas, the predetermined varying pricing rate data for each time slot (time period) and corresponding metering data, and the CCP rate data received from the exterior remote management server 100 when necessary and corresponding metering data, and providing such data to a remote management server. Also, the electronic power meter may individually manage the metering data related to each pricing rate data, resulting in a reduction of a consumer's financial burden, uninterrupted power supply by a power company, and a cost reduction of electric power generation and facilities.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An electronic power meter comprising:
a communication unit that receives a critical peak pricing rate data;
a memory that stores first metering data corresponding to the critical peak pricing rate data received via the communication unit, and second metering data corresponding to a predetermined varying pricing rate data, the memory storing the first metering data and the second metering data within different storage areas respectively; and
to a controller that calculates the metering data by applying a corresponding rate for each time slot according to the varying pricing rate data or the critical peak pricing rate data.

2. The electronic power meter of claim 1, wherein the critical peak pricing rate data comprises a starting time, an ending time and a peak rate with respect to a time slot for applying the critical peak pricing rate thereto.

3. The electronic power meter of claim 2, wherein the controller comprises a processing program of calculating the metering data by applying the peak pricing rate when a current time belongs to the time slot for applying the critical peak pricing rate thereto, and calculating the metering data by applying a time slot-based rate of the predetermined varying pricing rate when the current time does not belong to the time slot for applying the critical peak pricing rate thereto.

4. The electronic power meter of claim 1, wherein the varying pricing rate data employs a varying rate for each time slot.

5. A method for storing data in an electronic power meter comprising:
storing a critical peak pricing rate data into a first memory;
calculating metering data by applying the critical peak pricing rate data or a predetermined varying pricing rate data according to a current time; and
storing first metering data corresponding to the critical peak pricing rate data and second metering data corresponding to the predetermined varying pricing rate data into different storage areas.

6. The method of claim 5, wherein the critical peak pricing rate data comprises a starting time, an ending time and a peak rate with respect to a time slot for applying the critical peak pricing rate data thereto.

7. The method of claim 6, wherein the step of calculating the metering data by applying the critical peak pricing rate data or the predetermined varying pricing rate data according to the current time comprising:
calculating the metering data by applying the peak rate when the current time belongs to the time slot for applying the critical peak pricing rate data thereto, or
calculating the metering data by applying a time slot-based rate of the predetermined varying pricing rate data when the current time does not belong to the time slot for applying the critical peak pricing rate data thereto.
